(19) United States
(12) Patent Application Publication
(10) Pub. No.: US 2026/0010539 A1
(43) Pub. Date: Jan. 8, 2026

(54) CROSS-DOMAIN SEQUENTIAL RECOMMENDATION METHOD BASED ON TIME SERIES AND PROJECTION ENHANCEMENT

(71) Applicant: Nanjing University of Aeronautics and Astronautics, Jiangsu (CN)

(72) Inventors: Lvying CHEN, Jiangsu (CN); Ji ZHANG, Jiangsu (CN); Bohan LI, Jiangsu (CN); Sujie YU, Jiangsu (CN); Yuxi ZHANG, Jiangsu (CN)

(73) Assignee: Nanjing University of Aeronautics and Astronautics, Jiangsu (CN)

(21) Appl. No.: 19/183,903

(22) Filed: Apr. 20, 2025

(30) Foreign Application Priority Data
Jul. 4, 2024 (CN) 202410894871.6

(51) Int. Cl. G06F 16/2457

(52) U.S. Cl. CPC G06F 16/24578

(57) ABSTRACT

A cross-domain sequential recommendation method based on time series and projection enhancement. According to the present disclosure, first, single-domain and cross-domain interaction sequences are encoded by using a graph attention mechanism. To account for periodic variation of user preference, timestamp encoding is incorporated to capture temporal characteristics of user behavior. After combining the interaction sequences with the time encoding, a projection mechanism-based module is designed in the present disclosure to accurately capture unique features of a user in a specific domain and shared features in a mixed sequence, such that redundant information in a source domain is effectively prevented from being transmitted to a target domain. Finally, a contrastive learning auxiliary framework is designed to further enhance cross-domain sequence representation. The present disclosure effectively extracts the feature quality in each domain, mitigates the negative transfer through effective feature extraction, and ultimately improves the performance of cross-domain recommendation.

### CROSS-REFERENCE TO RELATED APPLICATION

This application claims the priority benefit of China application serial no. 202410894871.6, filed on Jul. 4, 2024. The entirety of the above-mentioned patent application is hereby incorporated by reference herein and made a part of this specification.

### BACKGROUND

### Technical Field

The present disclosure belongs to the big data processing technology, specifically relates to the technical field of cross-domain sequential recommendation, and particularly relates to a cross-domain sequential recommendation method based on time series and projection enhancement.

### Description of Related Art

Personalized recommendations aim to predict a user's possible future interactions through the user's historical interactions, thereby recommending items that may be of interest to the user. To alleviate persistent data sparsity in the recommendation system, cross-domain recommendation is proposed in the prior art. A domain with relatively dense data is called a source domain (A domain), and a domain with relatively sparse data is called a target domain (B domain). There are typically public users, public items, or public attributes between domains. User item interactions, attribute information, and auxiliary information in two or more domains (X domains) are provided, and the goal of the cross-domain recommendation task is to aggregate or migrate information of these domains to the target domain to result in more accurate recommendations at the target domain. Cross-domain recommendation is one of the research fields that have drawn much attention in recent years, and it can be applied to various cross-platform, cross-system, and cross-domain recommendation systems to enable users to quickly find articles they like, help users to jump out of information cocoons, and meanwhile promote the business growth of the platforms. For example, users may show similar preferences on different domains, such that Douyin can recommend advertisement videos that may be of interest to users according to the commodity purchase history of the users on the platform, and the recommendation accuracy and novelty are improved.

The cross-domain recommendation is mainly proposed to solve the problems of data sparsity, cold start, and the like in sequential recommendation. Common cross-domain recommendation uses the rich information of the source domain to supplement the data information of the target domain and thereby to obtain more accurate recommendation. Although many studies are devoted to the development of cross-domain recommendation, most existing studies only consider how to migrate information of a source domain into a target domain, which may cause the interference with information in the target domain by some unique information in the source domain.

For example, in the food field and the kitchen supplies field, if one usually buys organic and healthy products, for the kitchen field, healthy, high-end, and similar information can be shared, but low-fat, organic, and the like are food-specific information. In addition, the user's preference is periodic, and the purchasing preference in summer and some festivals is different.

Therefore, how to reduce useless information in the source domain information and reduce negative transfer in the information migration process and capturing the periodic or long-term preference change of a user are worthy of study.

### SUMMARY

The present disclosure aims to provide a cross-domain sequential recommendation method based on time series and projection enhancement, which is intended to solve the negative transfer in cross-domain sequential recommendation and capture cyclical preference of a user through a time series, thereby improving the recommendation precision.

Technical solution: provided is a cross-domain sequential recommendation method based on time series and projection enhancement, which includes the following steps:

S1, encoding item nodes and timestamps separately, and capturing dependency between mixed-domain items and single-domain items through three directed matrices, where the item nodes are encoded through a graph attention mechanism, and interdependency of the nodes in a global task is captured, the timestamps are mapped into a high-dimensional space, a time span is represented by using a vector dot product, and the time span is evaluated by comparing similarity in time embeddings, thereby capturing dependency and time characteristic between nodes in three interaction sequences;

S2, aggregating the item nodes and time nodes by using a multi-head attention mechanism, then extracting shared information of a mixed sequence and unique information of a specific domain through a mapping mechanism-based gated transmission module, and through an auxiliary task, mixing information of a cross-domain sequence to obtain prototype representation of each single-domain sequence and thereby enhance information features of each domain;

S3, processing a cross-domain interaction sequence by using a masking mechanism to obtain sequence representation of each single domain, using contrastive learning to help to enhance representation of the cross-domain sequence, and training on single-domain information extracted from the cross-domain sequence and the single-domain sequence; and

S4, predicting using the representations of the cross-domain sequence and the single-domain sequence, processing the sequences using a softmax function, and then selecting the top-ranked item from the domain's predictions as a next recommended item.

Further, the method includes extracting intra-domain unique information and inter-domain shared information through a mapping mechanism, such that negative transfer in cross-domain recommendation is alleviated by filtering useless information; in addition, cyclical preference of a user is captured through time encoding to improve accuracy of cross-domain recommendation.

Based on the above solution, in the method, A domain and B domain are taken to represent any two domains, and cross-domain sequential recommendation therebetween includes the following process:
for the A domain, an interaction sequence based on time order is expressed as S_{A}=[A₁, A₂, . . . . Aᵢ, . . . ];
for the B domain, an interaction sequence based on time order is expressed as S_{B}=[B₁, B₂, . . . , Bⱼ, . . . ];
a cross-domain interaction sequence obtained by combining the A domain and the B domain is expressed as S_{c}=[A₁, B₁, . . . . Aᵢ, Bⱼ . . . ], and each interaction in the sequence is recorded as an entity-event pair;
the method is characterized by capturing relationship between two items of the A domain and the B domain by constructing three directed matrices, and the three directed matrices are capable of being expressed as A^{a}∈{0, 1}^{|a|×|a|}, A^{b}∈{0, 1}^{|b|×|b|}, and A^{c}∈{0, 1}^{(|a|+|b|)×(|a|+|b|)};

Taking the A domain as an example, if Aⱼ is a next item of Aᵢ,

$${A}_{ij}^{a} = 1 ,$$

and otherwise,

$${A}_{ij}^{a} = 0 ;$$

A^{b} and A^{c} are processed in a manner the same as that of the A domain;
the method includes modeling items by applying a graph attention mechanism on sequential data to capture relationship between nodes, and taking the A domain as an example, a modeling expression is as follows:

$${G}_{i}^{0} = {A}^{a}$$

$${G}_{i}^{l} = ReLU ( {\sum }_{j ∈ N ( i )} {a}_{ij}^{l} \cdot {G}_{j}^{l - 1} [ j ] {W}^{X} )$$

where, N(i) is a neighbor node set of node vᵢ,

$${G}_{i}^{l}$$

is a representation or the neighbor node vᵢ at an l^{th} layer,

$${G}_{i}^{l - 1}$$

is a representation or the neighbor node vᵢ at the 1-l^{th} layer, W^{X} is the weight matrix of the X domain and is learnable, and

$${a}_{ij}^{l}$$

is the attention weight of the node vᵢ for the neighbor vⱼ at the l^{th} layer:

$${a}_{ij}^{l} = \frac{exp ( LeakyReLU ( {a}^{T} [ {G}_{i}^{l - 1} ‖ {G}_{j}^{l - 1} ] ) )}{{\sum }_{j ∈ N ( i )} exp ( LeakyReLU ( {a}^{T} \cdot [ {G}_{i}^{l - 1} ‖ {G}_{j}^{l - 1} ] ) )}$$

where, a is a learnable weight vector, and ∥ represents a concatenation operation; a final representation of each node is an output of a last layer of the attention mechanism, and a^{T} represents transpose of a of the matrix.

Similarly, the domain B is processed in a manner the same as that of the domain A.

Further, the step S1 defines temporal effect as a function of time span in continuous time space, and operations are as follows:
given a pair of interactions, (aᵢ, t₁) and (aⱼ, t₂), of a user u in a same domain, a function of time span is expressed as:

$$φ ( {t}_{1} - {t}_{2} ) = 𝒦 ( {t}_{1} , {t}_{2} ) = ϕ ( {t}_{1} ) \cdot ϕ ( {t}_{2} )$$

$$ϕ ( t ) \to {\sqrt{\frac{1}{{d}_{T}}} [ cos ( {w}_{1} t ) , sin ( {w}_{1} t ) , … , cos ( {w}_{{d}_{T}} t ) , cos ( {w}_{{d}_{T}} t ) ]}^{T}$$

where, · represents a dot product operation, and w=[w₁, . . . , w_{d}_{_{T}}]^{T} and φ(t₁−t₂) are used to measure time correlation between two timestamps.

Further, the step S2 includes embedding time encoding into sequence items by using a time-based encoder, and the process includes:
performing sequence padding, and then establishing the sequence by using a multi-head attention mechanism, where input sequence data are divided into a plurality of heads, each head is independently calculated, and finally concatenating is performed, thus ensuring consistency in sequence length; and
extracting shared information and unique information representation of each neighborhood domain relative to the mixed sequence through a projection mechanism-based module, and adding supplementary information extracted from the mixed sequence to features of each original domain, thus achieving modeling of inter-domain dependency.

Further, the specific operations of the step S2 include:
S21, expressing encoder's embedding of time encoding into sequence items as:

$${E}^{0} = [ {e}_{1} + {p}_{1} + {t}_{1} , {e}_{2} + {p}_{2} + {t}_{2} , … , {e}_{l} + {p}_{l} + {t}_{l} ]$$

where, e₁, p₁, and t₁ represent codes of item, position, and time of 1^{st} data in the sequence, respectively;
S22, performing sequence padding on the A domain and the B domain, where padded sequences are capable of being respectively expressed as S_{A}=[A₁, [pad], A₂, [pad], [pad], . . . ] and S_{B}[=[pad], B₁, [pad], B₂, . . . ], where [pad] is used to pad the sequence with items in a cross-domain interaction sequence S_{C} that do not belong to a current domain, a value of [pad] in the S_{A} is the number of items in the A domain, and the value of [pad] in the S_{B} is the number of items in the B domain;
S23, for the process of establishing a sequence through the multi-head attention mechanism, dividing input sequence data into a plurality of heads, independently calculating each head, and finally concatenating together, where attention-weighted output of a k^{th} head at an x^{th} layer is as follows:

$${H}_{k}^{x} = {\sum }_{q = 1}^{l} \frac{exp ( \frac{{Q}_{k} {K}_{q}^{T}}{\sqrt{d}} )}{{\sum }_{m = 1}^{l} exp ( \frac{{Q}_{k} {K}_{m}^{T}}{\sqrt{d}} )} \cdot {V}_{q}^{x}$$

where, Qᵢ, Kᵢ, and Vᵢ are obtained by subjecting an input to different linear transformations;
S24, further stabilizing a training process by using layer normalization and residual connection, where a formula is expressed as follows:

$${E}^{x + 1} = LN ( {E}^{x} + {FFN}^{x} ( {H}^{x} ) )$$

S25, extracting shared information and unique information representation of each neighborhood domain relative to the mixed sequence through a projection mechanism-based module, thereby achieving modeling, where a mathematical representation is as follows:

$$\{ \begin{matrix}{H}_{sha}^{A} = \frac{{H}_{C} \cdot {H}_{A}}{\vert {H}_{A} \vert} \frac{{H}_{A}}{\vert {H}_{A} \vert} \\ {H}_{uni}^{B} = {H}_{C} - {H}_{sha}^{A}\end{matrix}$$

where,

$${H}_{sha}^{A}$$

represents shared information feature of A in mixed information,

$${H}_{uni}^{A}$$

represents supplementary information unique to the B domain in the mixed information, and the supplementary information extracted from the mixed sequence is added to features of each original domain:

$${\hat{O}}^{A} = Mean ( {H}_{A} + {H}_{uni}^{A} ) .$$

Further, in the step S3, correlation of feature information in a sequence is increased by calculating weights between domains, and for the mixed sequence S_{C}, if μ_{B}=σ(Ô^{B}, O_{A})<0.5, an interaction item Bᵢ is masked as [m], a corresponding mask sequence is capable of being expressed as

$${\hat{S}}_{C}^{A} = [ {A}_{1} , [ m ] , … , {A}_{i} , {B}_{j} ] ,$$

and then a corresponding output

$${\hat{H}}_{C}^{A}$$

an attention encoder in the step S2.

Even further, to improve correlation between single-domain characterization and cross-domain characterization, in the method, an auxiliary task is constructed by using InfoNCE loss in contrastive learning to train single-domain and cross-domain sequences;
an auxiliary task for the A domain is capable of being expressed as follows:

$${ℒ}_{cl}^{A} = - log \frac{exp ( sim ( {f}_{C}^{A} ( {H}_{C} ) , {f}_{C}^{A} ( {\hat{H}}_{C} ) ) / τ ) )}{{\sum }_{{S}_{{C}^{′}}} ( exp ( sim {f}_{C}^{A} ( {H}_{C} ) , {f}_{C}^{A} ( {H}_{{C}^{′}} ) ) / τ )}$$

where,

$${f}_{C}^{A} ( \cdot )$$

represents calculation of a sequence average value of corresponding items of the A domain extracted from the mixed sequence, and sim(·) represents calculation of similarity between two vectors;
similarly, in the method,

$${ℒ}_{cl}^{B}$$

is capable of being calculated using the above method.

Beneficial effects: for the cross-domain sequential recommendation, the present disclosure, by deep analysis of the correlation of intra-domain items and the inter-domain relation, extracts intra-domain unique information and inter-domain shared information through a mapping mechanism, and filters the intra-domain unique information, thereby alleviating the negative transfer in the cross-domain recommendation; the temporal effect is expressed by time encoding to capture the periodic and long-term preferences of the items in the sequence, thus improving the recommendation efficiency.

### BRIEF DESCRIPTION OF THE DRAWINGS

FIG. 1 is a schematic flowchart of the method of the present disclosure; and

FIG. 2 is a flowchart of the operation of the method of the present disclosure.

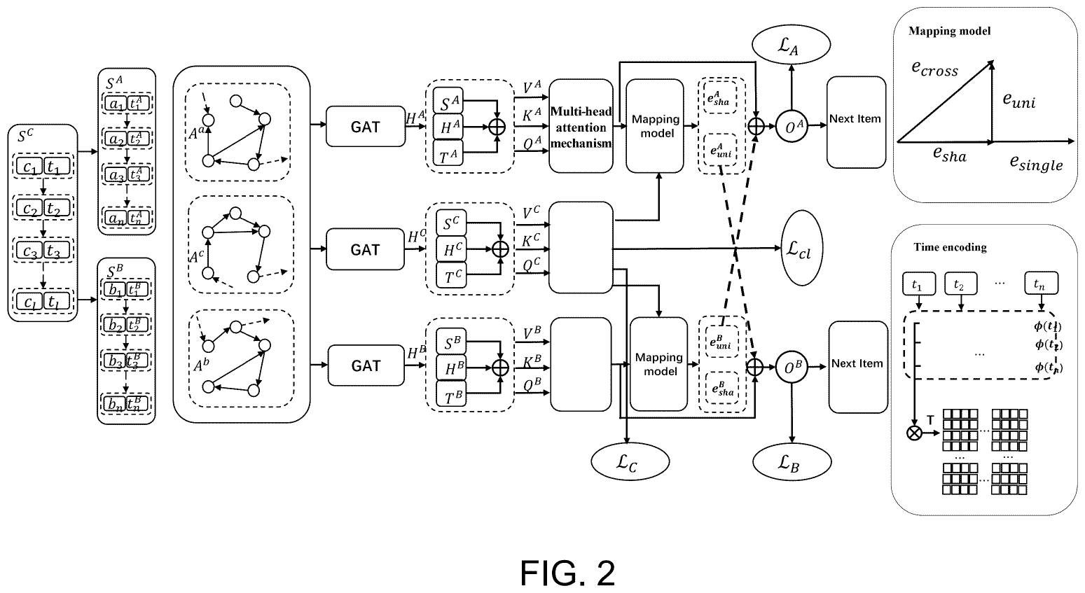

### DESCRIPTION OF THE EMBODIMENTS

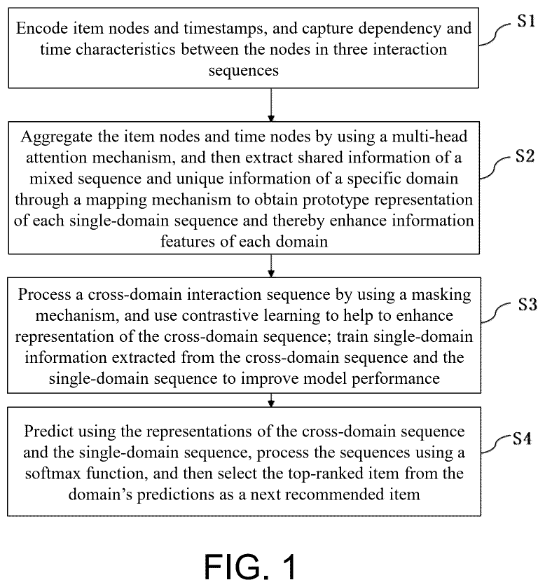

Referring to FIG. 1, a cross-domain sequential recommendation method based on time series and projection enhancement provided by the present disclosure includes the following steps.

S1, item nodes and timestamps are encoded separately, and dependency and time characteristics between the nodes in three interaction sequences are captured.

Assuming that there are an A domain (source domain) and a B domain (target domain), three sequences can be obtained according to the information of the two domains, namely sequences of the A domain, the B domain, and a mixture of the two domains based on time order. The present disclosure introduces three directed item-item matrices, A^{a}∈{0, 1}^{|a|×|a|}, A^{b}∈{0, 1}^{|b|×|b|}, and A^{c}∈{0, 1}^{(|a|+|b|)×(|a|+|b|)}; to represent the relationship between nodes, and if xⱼ is the next item of xᵢ in an X domain (denoting the A domain or the B domain),

$${A}_{ij}^{X} = 1 ;$$

otherwise,

$${A}_{ij}^{X} = 0 .$$

In this embodiment, to model the items between sequences, the present disclosure applies the graph attention mechanism on the sequential data. Taking the A domain as an example, if

$${G}_{i}^{0} = {A}^{a} ,$$

$${G}_{i}^{l} = R e LU ( {\sum }_{j ∈ N ( i )} {a}_{ij}^{l} \cdot {G}_{j}^{l - 1} [ j ] {W}^{X} )$$

where, N(i) is the neighbor node set of node vᵢ,

$${G}_{i}^{l}$$

is the representation of the neighbor node vᵢ at the l^{th} layer,

$${G}_{i}^{l - 1}$$

is the representation or the neighbor node vᵢ at the 1-l^{th} layer, W^{X} is the weight matrix of the X domain and is learnable, and aᵢⱼ^{l} is the attention weight of the node vᵢ for the neighbor vⱼ at the l^{th} layer:

$${a}_{i j}^{l} = \frac{exp ( Leaky ReLU ( {a}^{T} [ {G}_{i}^{l - 1} ‖ {G}_{j}^{l - 1} ] ) )}{{\sum }_{j ∈ N ( i )} exp ( LeakyReLU ( {a}^{T} \cdot [ {G}_{i}^{l - 1} ‖ {G}_{j}^{l - 1} ] ) )}$$

where a is a learnable weight vector, and ∥ represents a concatenation operation. The final representation of each node is the output of the last layer of the attention mechanism. The domain B is processed in a manner the same as that of the domain A.

Further, time span plays a crucial role in representing temporal effect and in revealing sequence patterns, so temporal effect is defined as a function of time span in continuous time space.

Given a pair of interactions, (aᵢ, t₁) and (aⱼ, t₂), of a user u in the same domain, the time span function can be expressed as:

$$φ ( {t}_{1} - {t}_{2} ) = 𝒦 ( {t}_{1} , {t}_{2} ) = ϕ ( {t}_{1} ) \cdot ϕ ( {t}_{2} )$$

$$ϕ ( t ) \to {\sqrt{\frac{1}{{d}_{T}}} [ cos ( {w}_{1} t ) , sin ( {w}_{1} t ) , … , cos ( {w}_{{d}_{T}} t ) , cos ( {w}_{{d}_{T}} t ) ]}^{T}$$

where · represents a dot product operation, w=[w₁, . . . , w_{d}_{_{T}}]^{T} represents different angular frequencies, and d_{T} represents the dimension of a vector. φ(t₁−t₂) is used to measure the time correlation between two timestamps.

S2, the item nodes and time nodes are aggregated by using a multi-head attention mechanism, then shared information of the mixed sequence and unique information of specific domains were extracted through a mapping mechanism-based gated transmission module, and through an auxiliary task, information of the cross-domain sequence is mixed to obtain prototype representation of each single-domain sequence and enhance information features of each domain.

In this embodiment, the present disclosure embeds time encoding into sequence items by using a time-based encoder, the input embedding of which is expressed as follows:

$${E}^{0} = [ {e}_{1} + {p}_{1} + {t}_{1} , {e}_{2} + {p}_{2} + {t}_{2} , … , {e}_{l} + {p}_{l} + {t}_{l} ]$$

where, e₁, p₁, and t₁ represent codes of item, position, and time of the 1^{st} data in the sequence, respectively.

To make the lengths of the sequences consistent, the sequences are processed by using padding techniques.

Taking S_{A} as an example, S_{A}=[A₁, [pad], A₂, [pad], [pad], . . . ], where [pad] is used to pad the sequence with items of the B domain in the cross-domain interaction sequence S_{C}, and for S_{B}, the operation is the same as that above, where [pad] is used to pad the sequence with items in the cross-domain interaction sequence S_{C} that do not belong to the current domain; the value of [pad] in S_{A} is the number of items in the A domain, and the value of [pad] in S_{B} is the number of items in the B domain;

In this step, the sequence is established through the multi-head attention mechanism, where the input sequence data is divided into a plurality of heads, each head is independently calculated, and finally concatenating is performed, where the attention-weighted output of the k^{th} head at the x^{th} layer is as follows:

$${H}_{k}^{x} = {\sum }_{q = 1}^{l} \frac{exp ( \frac{{Q}_{k} {K}_{q}^{T}}{\sqrt{d}} )}{{\sum }_{m = 1}^{l} exp ( \frac{{Q}_{k} {K}_{m}^{T}}{\sqrt{d}} )} \cdot {V}_{q}^{x}$$

where Qᵢ, Kᵢ, and Vᵢ are obtained by subjecting the input to different linear transformations.

To improve the expression capability of the model, the present disclosure uses the layer normalization and residual connection to further stabilize the training process, where the formula is expressed as follows:

$${E}^{x + 1} = LN ( {E}^{x} + {FFN}^{x} ( {H}^{x} ) )$$

To further model the inter-domain dependency, the shared information and unique information representation of each neighborhood domain relative to the mixed sequence are extracted through a projection mechanism-based module. Taking the A domain as an example:

$$\{ \begin{matrix}{H}_{sha}^{A} = \frac{{H}_{C} \cdot {H}_{A}}{\vert {H}_{A} \vert} \frac{{H}_{A}}{\vert {H}_{A} \vert} \\ {H}_{uni}^{B} = {H}_{C} - {H}_{sha}^{A}\end{matrix}$$

where,

$${H}_{sha}^{A}$$

represents shared information feature of A in mixed information,

$${H}_{uni}^{A}$$

represents supplementary information unique to the B domain in the mixed information, and the supplementary information extracted from the mixed sequence is added to features of each original domain:

$${\hat{O}}^{A} = Mean ( {H}_{A} + {H}_{uni}^{A} )$$

S3, a cross-domain interaction sequence is processed by using a masking mechanism to

obtain the sequence representation of each single domain, and then the contrastive learning is used to help to enhance the representation of the cross-domain sequence. To improve the model performance, a common training model is used to train the single-domain information extracted from the cross-domain sequence and the single-domain sequence.

In this embodiment, to make the feature information in the sequence more relevant, the present disclosure calculates the weights between the domains. For the mixed sequence S_{C}, if μ_{B}=σ(Ô^{B}, O^{A})<0.5, the interaction item Bᵢ is masked as [m], the mask sequence can be expressed as

$${\hat{S}}_{C}^{A} [ {A}_{1} , [ m ] , … , {A}_{i} , {B}_{j} ] ,$$

and then the corresponding output can be obtained by

$${\hat{H}}_{C}^{A}$$

using the attention encoder.

An auxiliary task is constructed by using the InfoNCE loss in contrastive learning, where:

$${ℒ}_{cl}^{A} = - log \frac{exp ( sim ( {f}_{C}^{A} ( {H}_{C} ) , {f}_{C}^{A} ( {\hat{H}}_{C} ) ) / τ ) )}{{\sum }_{{S}_{C ′}} ( exp ( sim ( {f}_{C}^{A} ( {H}_{C} ) , {f}_{C}^{A} ( {H}_{C ′} ) ) / τ )}$$

where,

$${f}_{C}^{A} ( \cdot )$$

represents the calculation or the sequence average value of corresponding items of the A domain extracted from the mixed sequence, and sim(·) represents the calculation of similarity between two vectors. Similarly,

$${ℒ}_{cl}^{B}$$

can be calculated using the above method.

In addition, to improve the overall performance of the model, the present disclosure trains the single-domain and cross-domain sequences separately. For single domains, the A domain and the B domain are trained separately. Taking the A domain as an example:

$${ℒ}_{A} = {\sum }_{t = 1}^{{T}_{A}} - log ( soft max ( {\hat{O}}_{{A}_{t}} {W}_{A} + {H}_{{C}_{t}} {W}_{A} ) )$$

where, Ô_{A}_{ₜ}∈ [symbol] and H_{C}_{ₜ}∈ [symbol] represent the item representations of the A-domain sequence and the cross-domain sequence at position t, respectively, and W_{A} is a learnable parameter.

For the cross-domain sequence, the loss function is decomposed into two parts for optimization, and even if continuous items exist in the cross-domain sequence, the prediction results of other domains will not be influenced. The training is as follows:

$${ℒ}_{C} ( {S}_{C} , t ) = \{ \begin{matrix}{\sum }_{t}^{{T}_{A}} - log ( soft max ( {H}_{{C}_{t}} {W}_{A} ) ) \\ {\sum }_{t}^{{T}_{B}} - log ( soft max ( {H}_{{C}_{t}} {W}_{B} ) )\end{matrix} .$$

where, W_{A} and W_{B} represent learnable parameters.

S4, prediction is performed using representations of the cross-domain sequence and the single-domain sequence, the sequences are processed using a softmax function, and then the top-ranked item from the domain's predictions is selected as a next recommended item.

In the prediction phase, the present disclosure uses cross-domain and single-domain characterization for prediction.

Taking the A domain as an example:

$${x}_{i} = {max}_{{x}_{i} ∈ X} ( soft max ( {\hat{O}}_{\vert A \vert} {W}_{A} + {H}_{\vert C \vert} {W}_{A} ) )$$

where, Ô_{|A|}∈ [symbol] and H_{|C|}∈ [symbol] represent item representations of the A domain sequence and the cross-domain sequence, respectively, and W_{A} is a learnable parameter.

Through the above process, the prediction score of each item is obtained, and then the top-ranked item from the domain's predictions is selected as the next recommended item.

To demonstrate the effectiveness of our solution, in the example, it is compared with four types of baseline methods, including a traditional recommendation method, a sequential recommendation method, a cross-domain recommendation method, and a cross-domain sequential recommendation method.

The results demonstrate that:
(1) For the sequential recommendation model, it can be observed that the performance of the SASRec model using the attention mechanism is better than that of the GRU-based sequential recommendation model, and the performance of the TiSASRec model is better than that of other models not using time information, which shows that the idea of using time information to process data is effective.
(2) TP-CDSR is better than all baseline models in index; one reason is that processing some training data with a large time span by using time encoding has advantages over the case where only time interval information is used, and the another reason is that the mapping mechanism can enable effective extraction of effective information in the source domain, and thereby the recommendation performance is improved.

The present disclosure extracts intra-domain unique information and inter-domain shared information through a mapping mechanism, such that negative transfer in cross-domain recommendation is alleviated by filtering useless information; in addition, cyclical preference of a user is captured through time encoding to improve the accuracy of cross-domain recommendation.

According to the above technical solution and implementation steps, the method of the present disclosure can be implemented by being divided into an embedding module, an attention encoding and mapping module, a model training module, and a prediction module.

Embedding module: the dependency between mixed-domain items and single-domain items is captured through three directed matrices, the item nodes are encoded through a graph attention mechanism, and interdependency of the nodes in a global task is captured; the timestamps are mapped into a high-dimensional space, the time span is represented by using a vector dot product, and the time span is evaluated by comparing the similarity in time embeddings.

Attention encoding and mapping module: the item nodes and time nodes are aggregated by using a multi-head attention mechanism, then the results obtained are subjected to a mapping mechanism-based gated transmission module to extract shared information of the mixed sequence and unique information of a specific domain, and through an auxiliary task, the information of the cross-domain sequence is mixed to obtain the prototype representation of each single-domain sequence and thereby enhance the information features of each domain.

Model training module: the cross-domain interaction sequence is processed by using a masking mechanism to obtain the sequence representation of each single domain, and then the contrastive learning is used to help to enhance the representation of the cross-domain sequence; the single-domain information extracted from the cross-domain sequence and the single domain sequences are trained by using a common training model.

The implementation of the embodiment of the present disclosure in the prediction module includes predicting using the representations of the cross-domain sequence and the single-domain sequence, processing the sequences using a softmax function, and then selecting the top-ranked item from the domain's predictions as the next recommended item.

In conclusion, the present disclosure incorporates a mapping mechanism to extract intra-domain unique information and inter-domain shared information, such that negative transfer in cross-domain recommendation is alleviated by filtering useless information; in addition, cyclical preference of a user is captured through time encoding to improve the accuracy of cross-domain recommendation.

### EXAMPLE

To verify the effectiveness of the method, in the present disclosure, data processing was performed on two public datasets, Food-Kitchen and Movie-Book, to make them accord with the experimental conditions of the present disclosure.

For the product recommendation task, the present disclosure used Hit Ratio (HR) and Normalized Discounted Cumulative Gain (NDCG) as evaluation criteria. The present disclosure selected four types of methods for comparison, namely a traditional recommendation system, a sequential recommendation system, a cross-domain recommendation system, and a cross-domain recommendation sequential recommendation system.

TABLE 1
Recommendation results on Food-Kitchen dataset

| | Food-domain | | | | | Kitchen-domain | | | | | | |
|---|---|---|---|---|---|---|---|---|---|---|---|---|
| | | NDCG | | HR | | | | NDCG | | HR | | |
| Method | MRR | @5 | @10 | @1 | @5 | @10 | MRR | @5 | @10 | @1 | @5 | @10 |
| ItemKNN | 3.92 | 3.51 | 3.97 | 2.41 | 4.59 | 5.98 | 1.89 | 1.28 | 1.75 | 0.58 | 1.99 | 3.26 |
| B [symbol] M [symbol] | 4.10 | #Z.899;.55 | 4.03 | 2.42 | 4.51 | 5.92 | 2.01 | 1.45 | 1. [symbol] 5 | 0.73 | 2.18 | 3.43 |
| GRU [symbol] | 5.79 | 5.48 | [symbol] .13 | 3.63 | 7.12 | [symbol] .11 | 3.06 | 2.55 | [symbol] .10 | 1.61 | 3.50 | [symbol] .22 |
| SASRec | 7.30 | 6.90 | 7.79 | 4.73 | 8.92 | 11. [symbol] | 3.79 | [symbol] .35 | 3.93 | 1.92 | 4.78 | 6.62 |
| T [symbol] SA [symbol] Rec | 7.88 | 7.23 | [symbol] .24 | 5.07 | 9.36 | 12.44 | 3.98 | [symbol] .41 | 4.09 | 2.11 | 4.88 | 6.84 |
| NC [symbol] -MKP | 4.4 [symbol] | [symbol] .94 | 4. [symbol] 1 | 2.68 | 5.10 | 6.86 | 2.18 | 1.57 | 2.0 [symbol] | 0.91 | 2.23 | 3.65 |
| C [symbol] Net | 4.13 | 3.61 | 4.14 | 2.42 | 4.77 | 6.35 | 2.17 | 1.50 | 2.11 | 0. [symbol] | 2.07 | 3.71 |
| [symbol] -Net | 7.68 | 7.32 | 8.1 [symbol] | 5.2 [symbol] | 9.25 | 11.75 | 3.5 [symbol] | 2.98 | 3.73 | 1.57 | [symbol] | 6.67 |
| PSJNet | 8.33 | 8. [symbol] 7 | [symbol] .77 | 5.73 | 1 [symbol] .28 | 12.45 | 4.1 | 3.68 | 4.32 | 2.14 | 5.17 | 7.15 |
| C [symbol] DS [symbol] | 8.91 | 8.65 | 9.71 | 5.84 | 11.24 | 14.54 | [symbol] .65 | 4.16 | [symbol] .94 | 2.51 | [symbol] .74 | 8.18 |
| TP-CDS [symbol] | 10.33 | 10.51 | 11.25 | 7.81 | 12.79 | 16.21 | 4.97 | 4.72 | 5.16 | 3.48 | 5.97 | 8.62 |
| Impr [symbol] | [symbol] .93 | 21. [symbol] | 15.8 [symbol] | 33.7 [symbol] | 1 [symbol] .79 | 11.49 | [symbol] .88 | 13.46 | 4.45 | 38.6 [symbol] | 4.01 | [symbol] .39 |

[symbol]

indicates data missing or illegible when filed

TABLE 2
Recommendation results on Movie-Book dataset

| | Movie-domain | | | | | | Book-domain | | | | | |
|---|---|---|---|---|---|---|---|---|---|---|---|---|
| | | NDCG | | HR | | | | ND [symbol] | | HR | | |
| Method | MRR | @5 | @10 | @1 | @5 | @10 | MRR | @5 | @10 | @1 | @5 | @10 |
| ItemKNN | 2.92 | 2.17 | [symbol] .88 | 1.26 | [symbol] .13 | 5.35 | 1.26 | 0. [symbol] | 1.1 [symbol] | [symbol] .48 | 1.25 | 2. [symbol] |
| B [symbol] M [symbol] | 2.9 [symbol] | 2.18 | [symbol] .80 | 1. [symbol] | 3.0 [symbol] | 4.95 | 1.27 | 0.8 [symbol] | 1. [symbol] 7 | [symbol] .48 | 1.23 | 2.25 |
| GRU [symbol] | 5.79 | 5.4 [symbol] | 6.13 | [symbol] | 7.12 | 9.11 | 3.0 [symbol] | 2. [symbol] | 3.10 | 1.61 | 3.50 | 5.22 |
| SASRec | 7.30 | 6. [symbol] 0 | [symbol] .79 | 4. [symbol] 3 | 8.92 | 11.68 | 3.79 | 3.35 | 3.9 [symbol] | 1.92 | 4.78 | 6. [symbol] |
| T [symbol] SA [symbol] Rec | 7.88 | 7.23 | 8.24 | 5.07 | 9.36 | 12.44 | 3.98 | [symbol] .41 | 4.09 | 2.11 | 4.88 | 6.84 |
| NC [symbol] -MKP | [symbol] .0 [symbol] | 2.26 | 2.96 | 1.41 | 3. [symbol] | [symbol] .3 | 1.43 | 1. [symbol] 6 | 1.26 | 0.6 [symbol] | 1.39 | 2.18 |
| C [symbol] Net | 3.07 | 2.42 | 3.01 | 1.31 | 3.48 | 5.35 | 1.45 | 1.04 | 1.28 | 0.64 | 1.44 | 2.1 [symbol] |
| [symbol] -Net | 4.16 | [symbol] . [symbol] 2 | [symbol] .17 | 2.52 | 4.75 | 6. [symbol] | 2.17 | 1.8 [symbol] | 2.0 [symbol] | 1.43 | 2.25 | 2.84 |
| PSJNet | 4.63 | 4. [symbol] 6 | 4.7 [symbol] | 2.7 [symbol] | 5.3 | 7.53 | 2.44 | 2.07 | 2.3 [symbol] | 1.66 | 2.58 | 3.28 |
| C [symbol] DS [symbol] | 4.94 | [symbol] .0 [symbol] | 6.0 [symbol] | 3.24 | 6.6 [symbol] | 9.91 | 2.74 | 2.7 [symbol] | 3.08 | 2.23 | 3. [symbol] | 4.22 |
| TP-CDS [symbol] | 7.68 | 7.32 | 7.96 | 4.22 | 8.54 | 12.40 | 3.23 | 2.96 | 3. [symbol] 7 | 2.51 | 3.90 | 4.95 |
| Impr [symbol] | 55.47 | 44.95 | 30.70 | 30.25 | 28. [symbol] | 25.13 | 17.88 | 6.09 | 6.17 | 12.5 [symbol] | 18.18 | 16. [symbol] 9 |

[symbol]

indicates data missing or illegible when filed

Specifically, Tables 1 and 2 show the experimental results of the present disclosure and the comparative methods on Food-Kitchen and Movie-Book datasets, respectively, and it can be seen that the method proposed by the present disclosure is better than other models in both HR and NDCG indexes on both datasets.

The above description is only a preferred embodiment of the present disclosure, and it should be noted that, for those of ordinary skill in the art, many variations and improvements can be made without departing from the inventive concept of the present disclosure, and these should also be regarded as the protection scope of the present disclosure.

What is claimed is:

1. A cross-domain sequential recommendation method based on time series and projection enhancement, comprising the following steps:
S1, encoding item nodes and timestamps separately, and capturing dependency between mixed-domain items and single-domain items through three directed matrices, wherein the item nodes are encoded through a graph attention mechanism, and interdependency of nodes in a global task is captured, the timestamps are mapped into a high-dimensional space, a time span is represented by using a vector dot product, and the time span is evaluated by comparing similarity in time embeddings, thereby capturing dependency and time characteristic between nodes in three interaction sequences;
S2, aggregating the item nodes and time nodes by using a multi-head attention mechanism, then extracting shared information of a mixed sequence and unique information of a specific domain through a mapping mechanism-based gated transmission module, and through an auxiliary task, mixing information of a cross-domain sequence to obtain prototype representation of each of single-domains sequences and thereby enhance information features of each of domains;
S3, processing a cross-domain interaction sequence by using a masking mechanism to obtain sequence representation of each of single-domains, using contrastive learning to enhance representation of the cross-domain sequence, and training on single-domain information extracted from the cross-domain sequence and the single-domain sequences; and
S4, predicting using the representations of the cross-domain sequence and the single-domain sequences, processing sequences using a softmax function, and then selecting a top-ranked item from the domains' predictions as a next recommended item.

2. The cross-domain sequential recommendation method based on the time series and the projection enhancement according to claim 1, wherein the method comprises extracting intra-domain unique information and inter-domain shared information through a mapping mechanism, such that negative transfer in cross-domain recommendation is alleviated by filtering useless information; in addition, cyclical preference of a user is captured through time encoding to improve accuracy of the cross-domain recommendation.

3. The cross-domain sequential recommendation method based on the time series and the projection enhancement according to claim 1, wherein in the method, A domain and B domain are taken to represent any two domains, and the cross-domain sequential recommendation therebetween comprises the following process:
for the A domain, an interaction sequence based on time order is expressed as S_{A}=[A₁, A₂, . . . . Aᵢ, . . . ];
for the B domain, an interaction sequence based on the time order is expressed as S_{B}=[B₁, B₂, . . . , Bⱼ, . . . ];
the cross-domain interaction sequence obtained by combining the A domain and the B domain is expressed as S_{C}=[A₁, B₁, . . . . Aᵢ, Bⱼ . . . ], and each of interactions in the sequence is recorded as an entity-event pair;
the method captures relationship between two items in the A domain and the B domain by constructing the three directed matrices expressed as: A^{a}∈{0, 1}^{|a|×|a|}, A^{b}∈={0, 1}^{|b|×|b|}, and A^{c}∈={0, 1}^{(|a|+|b|)×(|a|+|b|)};
in an X domain, if xⱼ is a next item of xᵢ,
$${A}_{ij}^{X} = 1 ;$$
otherwise,
$${A}_{ij}^{X} = 0 ;$$
the method comprises modeling items by applying the graph attention mechanism on sequential data to capture relationship between nodes, and taking the A domain as an example, a modeling expression is as follows:
$${G}_{i}^{0} = {A}^{a}$$
$${G}_{i}^{l} = Re LU ( {\sum }_{j ∈ N ( i )} {a}_{ij}^{l} \cdot {G}_{j}^{l - 1} [ j ] {W}^{X} )$$
wherein, N(i) is a neighbor node set of node vᵢ,
$${G}_{i}^{l}$$
is a representation or the seignior node vᵢ at an l^{th} layer, W^{X} is a weight matrix of the X domain and is learnable, and
$${a}_{ij}^{l}$$
is an attention weight of the node vᵢ for a neighbor vⱼ at a l^{th} layer:
$${a}_{ij}^{l} = \frac{exp ( LeakyReLU ( {a}^{T} [ {G}_{i}^{l - 1} ‖ {G}_{j}^{l - 1} ] ) )}{{\sum }_{j ∈ N ( i )} exp ( LeakyReLU ( {a}^{T} \cdot [ {G}_{i}^{l - 1} ‖ {G}_{j}^{l - 1} ] ) )}$$
wherein, a is a learnable weight vector, and ∥ represents a concatenation operation; a final representation of each of the nodes is an output of a last layer of the attention mechanism;
similarly, the domain B is processed in a manner the same as that of the domain A.

4. The cross-domain sequential recommendation method based on the time series and the projection enhancement according to claim 1, wherein the step S1 defines temporal effect as a function of the time span in continuous time space, and specific operations are as follows:
given a pair of interactions, (aⱼ, t₁) and (aⱼ, t₂), of a user u in a same domain, a function of the time span is expressed as:
$$φ ( {t}_{1} - {t}_{2} ) = 𝒦 ( {t}_{1} , {t}_{2} ) = ϕ ( {t}_{1} ) \cdot ϕ ( {t}_{2} )$$
$$ϕ ( t ) \to {\sqrt{\frac{1}{{d}_{T}}} [ cos ( {w}_{1} t ) , sin ( {w}_{1} t ) , … , cos ( {w}_{{d}_{T}} t ) , cos ( {w}_{{d}_{T}} t ) ]}^{T}$$
wherein, · represents a dot product operation, and w=[w₁, . . . , w_{d}_{_{T}}]^{T} and φ(t₁−t₂) are used to measure time correlation between two the timestamps.

5. The cross-domain sequential recommendation method based on the time series and the projection enhancement according to claim 1, wherein the step S2 comprises embedding time encoding into sequence items by using a time-based encoder, and the process comprises:
performing sequence padding, and then establishing the sequences by using the multi-head attention mechanism, wherein input sequence data are divided into a plurality of heads, each head is independently calculated, and finally concatenating is performed, thus ensuring consistency in sequence length; and
extracting the shared information and unique information representation of each neighborhood domain relative to the mixed sequence through a projection mechanism-based module, and adding supplementary information extracted from the mixed sequence to features of each of original domains, thus achieving modeling of inter-domain dependency.

6. The cross-domain sequential recommendation method based on the time series and the projection enhancement according to claim 5, wherein specific operations of the step S2 comprise:
S21, expressing encoder's embedding of time encoding into sequence items as:
$${E}^{0} = [ {e}_{1} + {p}_{1} + {t}_{1} , {e}_{2} + {p}_{2} + {t}_{2} , … , {e}_{l} + {p}_{l} + {t}_{l} ]$$
wherein, e₁, p₁, and tᵢ represent codes of item, position, and time of 1^{st} data in the sequences, respectively;
S22, performing sequence padding on A domain and B domain, wherein padded sequences are capable of being respectively expressed as S_{A}[=[A₁, [pad], A₂, [pad], [pad], . . . ] and S_{B}=[pad], B₁, [pad], B₂, . . . ], wherein [pad] is used to pad the sequence with items in the cross-domain interaction sequence S_{C} that do not belong to a current domain, a value of [pad] in the S_{A} is the number of items in the A domain, and the value of [pad] in the S_{B} is the number of items in the B domain;
S23, for the process of establishing a sequence through the multi-head attention mechanism, dividing input sequence data into a plurality of heads, independently calculating each head, and finally concatenating together, wherein attention-weighted output of a k^{th} head at an x^{th} layer is as follows:
$${H}_{k}^{x} = {\sum }_{q = 1}^{l} \frac{exp ( \frac{{Q}_{k} {K}_{q}^{T}}{\sqrt{d}} )}{{\sum }_{m = 1}^{l} xp ( \frac{{Q}_{k} {K}_{m}^{T}}{\sqrt{d}} )} \cdot {V}_{q}^{x}$$
wherein, Qᵢ, Kᵢ, and Vᵢ are obtained by subjecting an input to different linear transformations;
S24, further stabilizing a training process by using layer normalization and residual connection, wherein a formula is expressed as follows:
$${E}^{x + 1} = LN ( {E}^{x} + {FFN}^{x} ( {H}^{x} ) )$$
S25, extracting the shared information and the unique information representation of each neighborhood domain relative to the mixed sequence through the projection mechanism-based module, thereby achieving modeling, wherein a mathematical representation is as follows:
$$\{ \begin{matrix}{H}_{sha}^{A} & = \frac{{H}_{C} \cdot {H}_{A}}{\vert {H}_{A} \vert} \frac{{H}_{A}}{\vert {H}_{A} \vert} \\ {H}_{uni}^{B} & = {H}_{C} - {H}_{sha}^{A}\end{matrix}$$
wherein,
$${H}_{sha}^{A}$$
represents shared information feature of A in mixed information,
$${H}_{uni}^{A}$$
represents the supplementary information unique to the B domain in the mixed information, and the supplementary information extracted from the mixed sequence is added to features of each of the original domains:
$${\hat{O}}^{A} = Mean ( {H}_{A} + {H}_{uni}^{A} ) .$$

7. The cross-domain sequential recommendation method based on the time series and the projection enhancement according to claim 1, wherein in the step S3, correlation of feature information in a sequence is increased by calculating weights between domains, and for the mixed sequence S_{C}, if μ_{B}=σ(Ô^{B}, O_{A})<0.5, an interaction item Bᵢ is masked as [m], a corresponding mask sequence is capable of being expressed as
$${\hat{S}}_{C}^{A} = [ {A}_{1} , [ m ] , … , {A}_{i} , {B}_{j} ] ,$$
and then a corresponding output
$${\hat{H}}_{C}^{A}$$
is obtained by using an attention encoder in the step S2.

8. The cross-domain sequential recommendation method based on the time series and the projection enhancement according to claim 6, wherein to improve correlation between single-domain characterization and cross-domain characterization, in the method, the auxiliary task is constructed by using InfoNCE loss in contrastive learning to train single-domain and the cross-domain sequences;
the auxiliary task for the A domain is capable of being expressed as follows:
$${ℒ}_{cl}^{A} = - log \frac{exp ( sim ( {f}_{C}^{A} ( {H}_{C} ) , {f}_{C}^{A} ( {\hat{H}}_{C} ) ) / τ ) )}{{\sum }_{{S}_{{C}^{′}}} ( exp ( sim ( {f}_{C}^{A} ( {H}_{C} ) , {f}_{C}^{A} ( {H}_{{C}^{′}} ) ) / τ )}$$
wherein,
$${f}_{C}^{A} ( \cdot )$$
represents calculation of a sequence average value of corresponding items of the A domain extracted from the mixed sequence, and sim(·) represents calculation of similarity between two vectors;
similarly, in the method,
$${ℒ}_{cl}^{B}$$
is capable of being calculated using the above method.
